(19) United States
(12) Patent Application Publication
(10) Pub. No.: US 2018/0339777 A1
(43) Pub. Date: Nov. 29, 2018

(54) HIGH BACKREST PASSENGER SEAT

(71) Applicant: AirGo Design Pte., Ltd., The Central Singapore (SG)

(72) Inventor: Alireza Yaghoubi, Kuala Lumpur (MY)

(21) Appl. No.: 15/606,401

(22) Filed: May 26, 2017

(51) Int. Cl. B64D 11/06; B60N 2/46; B60N 2/44; B60N 2/64; B64D 11/00; B61D 33/00

(52) U.S. Cl. CPC B64D 11/0646; B60N 2/46; B61D 33/005; B60N 2/643; B64D 11/00151; B60N 2/4495

(57) ABSTRACT

A high seatback assembly can accommodate the height of an average passenger in an upright sitting posture while also providing high visibility behind the seat. The tapered geometry of the seatback is devised to allow sufficient visibility behind the seat while also providing ample structure to support a person seated in the seat. The seatback geometry can be further configured to include service modules such as integrated storage pocket, widescreen entertainment unit (display), etc. Additionally, the resulting gap between neighboring seats improves visibility and prevents claustrophobia in high-density seating configurations, such as on airplanes, buses, boats, or other vehicles.

### BACKGROUND

### Field

The present disclosure relates to seats, including passenger seats for various vehicles. The disclosure also relates to features of seats, including headrests and storage pockets. Certain features may be particularly relevant with vehicles for which seatback height is constrained by safety requirements.

### Description of the Related Art

Passenger seats in highly-regulated mass transportation vehicles such as aircrafts, trains and watercrafts must provide both comfort and safety to passengers. These goals can often conflict. For example, it may be desirable to make seats small to leave a sufficiently large unobstructed area such that a person responsible for safety (such as an airplane crew member) can see if somebody is in an aisle. Otherwise, a person might be accidentally left-behind during an emergency evacuation or have a safety-related issue that cannot be seen. However, a seat that is small enough to provide this visibility may be too small for some passengers to sit comfortably.

To strike a balance between these objectives, many seats include a fixed seatback and an extendible headrest to provide head support for the passenger. The fixed seatback is set at a low height for visibility, and the head and neck support can be adjusted higher for comfort.

There are a number of issues associated with this approach. First, the adjustment feature is far from intuitive and passengers are usually unaware of its existence. Second, the headrest, as a moving part which is regularly subjected to abuse load and cyclic fatigue, has a limited lifetime and upon mechanical failure can easily detach from the seatback, not only causing serious hazard but also removing the seat from service midflight. Third, the extra moving parts are expensive, both directly in terms of increased production cost, and indirectly in added weight which leads to higher fuel consumption. Finally, mechanical hinges and slides that facilitate adjustability and extension are difficult to mask using padding and can therefore cause discomfort over time.

The seating industry is in need of innovative solutions that can offer a simplified system balancing safety, human factors, production cost, manufacturability, weight-saving, passenger comfort, and visual appeal, among others.

### SUMMARY

In one embodiment, a passenger seat with an extended backrest can be tapered in a fashion to satisfy cabin viewing regulations, yet accommodate a fixed headrest which is ergonomically positioned and hence requires no moving parts. The headrest can comprise a variety of multi-density foam laminates, fiberfill, reinforcements and memory foam to provide omni-directional head and neck support.

The seatback assembly can further include a literature pocket (or storage space) that is seamlessly integrated and therefore fortifies structural integrity. A wide-screen entertainment unit (or a display), whether as part of the seat or a passenger's own device (e.g. electronic tablets) can be also fitted into the seatback assembly and conceal the underlying storage space.

Moreover, the resulting gap between neighboring seats, due to the tapered geometry of the seatback which improves visibility, may promote a sense of spaciousness, as opposed to claustrophobia, in high-density seating configurations.

In a further embodiment, a passenger seat assembly can provide high visibility behind the seat while also having a high seatback. The seat assembly can include a lower body section positioned to receive a lower body of a user in a seated position. The seat assembly can also include an upper body section positioned to receive an upper body of a user in a seated position. The upper body section can be operably connected to the lower body section and define a profile in the coronal plane such that a standing-person having a height of 5 feet behind the seat assembly can be seen by somebody in front of the seat assembly in the context of an airplane cabin. The profile can include a top at least 45 inches from the ground and two sides comprising tapered portions at an angle between 120 and 160 degrees. The seat assembly can also include a display disposed on a rear side of the upper body section, at or above a bottom of the tapered portions, and having a diagonal size of at least 9 inches.

In a further embodiment, a passenger seat assembly can provide high visibility behind the seat while also having a high seatback. The seat assembly can include a lower body section positioned to receive a lower body of a user in a seated position. The seat assembly can also include an upper body section positioned to receive an upper body portion of a user in a seated position. The upper body section can be operably connected to the lower body section and define a profile in the coronal plane. The profile in the coronal plane can include a top portion defining a highest point on the seatback and a maximum horizontal width, the maximum horizontal width occurring at an intermediate portion. A substantially triangular area in the coronal plane can be defined on either side of the seat by a horizontal line tangent to the top portion, a vertical line tangent to the profile at the maximum horizontal width, and the profile. The substantially triangular area can be at least 20 square inches.

### BRIEF DESCRIPTION OF THE DRAWINGS

A more thorough understanding of the present invention may be achieved by referring to the detailed description and claims along with the accompanying figures.

FIG. 1 is a side by side comparison of a 50th percentile height male passenger in a prior art seat (left) and a redesigned seat with high seatback (right).

FIG. 2 is a front view of a multi-seat assembly with multi-level tapering of the high seatback, as well as a 50th percentile height male passenger in sitting position and a 5th percentile height female passenger in standing position behind the seat row.

FIG. 3 is a front view of a multi-seat assembly with continuous single level tapering of the high seatback.

FIG. 4A is a perspective view of a fixed ergonomic headrest including side bolsters and neck support.

FIG. 4B is a perspective view of the headrest of FIG. 4A, with a passenger seated.

FIG. 5A is a rear view of a seatback assembly showing an integrated literature pocket and display.

FIG. 5B is a perspective view of the seatback assembly of FIG. 5A.

FIG. 6 is a perspective view of a seat assembly showing the improved ergonomics of passenger's line of sight in an extended seatback.

FIG. 7 is a profile view of an upper body section of a seat assembly.

### DETAILED DESCRIPTION

The following description is merely illustrative in nature and is not intended to limit the embodiments described herein. Moreover, there is no intention to be bound by any expressed or implied theory presented in the preceding technical field, background, brief summary or the following detailed description.

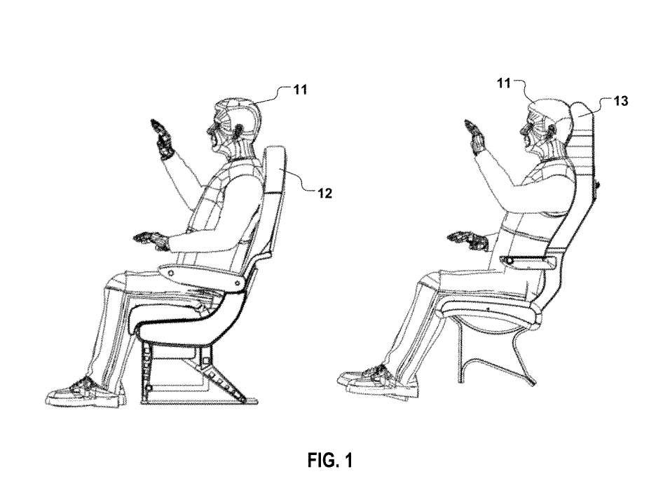

FIG. 1 is a side by side comparison of a 50th percentile height male passenger 11 in a prior art seat 12 and a redesigned seat with a high seatback 13. The seatback 13 can form a generally vertical upper body section that receives an upper body of the passenger 11, and be connected to a generally horizontal lower body section that receives a lower body of the passenger. The upper body and lower body sections can optionally rotate relative to each other, such that the seat 12 can move into a reclined position (or other positions). The seat 12 can optionally include other features such as armrests and footrests.

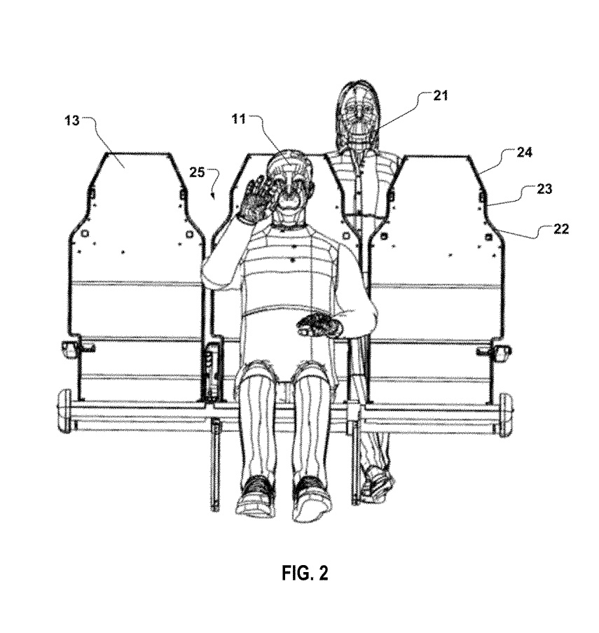

It is evident that the seatback in the prior art seat is shorter than the sitting height of an average male passenger (generally considered to be 5 feet and 9 inches) and hence does not provide adequate head or neck support. FIG. 2 is a front view of a seat assembly with multi-level tapering of the high seatback 13 in triple configuration, as well as a 50th percentile height male passenger 11 in sitting position and a 5th percentile height female passenger 21 (generally considered to be 5 feet) in standing position behind the seat row. The seat row shows three seats arranged in series. The seats can be directly attached to each other or be mounted on a shared frame providing support from the floor. Although the seats here are shown in a group of three, they can also be in groups of 2, 4, or more than 4.

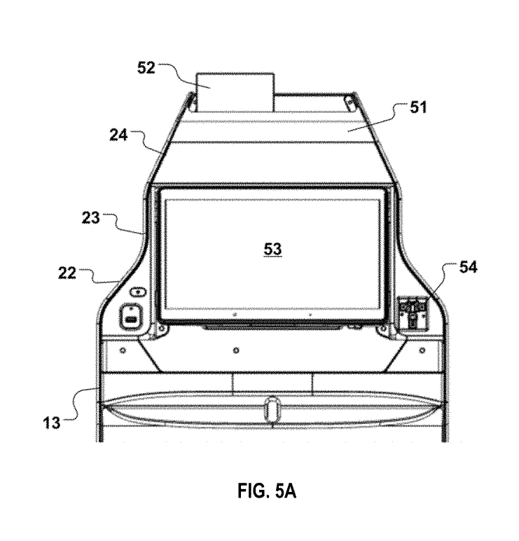

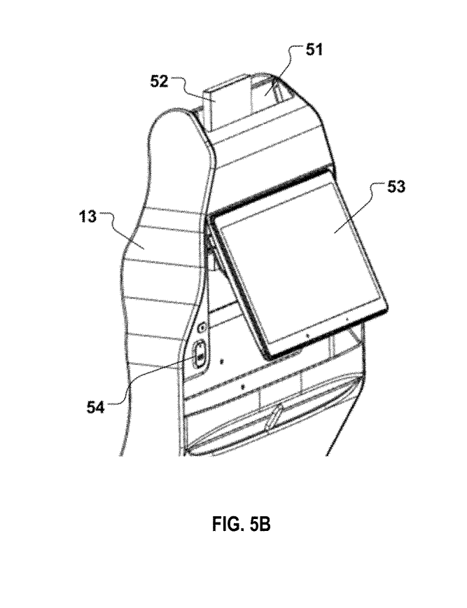

In this particular example, a non-continuous double tapering is depicted on the side of the seat. This configuration includes a first (lower) tapered portion 22 at an angle, followed by a vertical portion 23, and a second (higher) tapered portion 24 which may or may not have a similar angle to that of the first tapered portion 22. As further discussed herein and depicted in FIG. 5, the vertical portion 23 can provide space for a rectangular element such as a display. Further, the lower tapered portion 22 can optionally correspond to a shoulder height of a 50th percentile height male (for example, approximately 23 inches from the lower body section of the seat). The vertical portion 23 can correspond with a neck portion of the 50th percentile height male (for example, extending approximately 4.5 inches). The higher tapered portion 24 can optionally correspond to the head of the 50th percentile height male, with the top of the seat being at approximately 45 inches (or, for example, being at least 45 inches). The tapered portions can have angles between 120 degrees and 160 degrees. This shape can define a profile of the seat, more particularly a profile of the upper body section or seatback of the seat in the coronal plane (for example, when the seat is in a normal, upright position). However, as shown in FIG. 1, portions of the upper body section may still be angled with respect to the ground while in a normal, upright position.

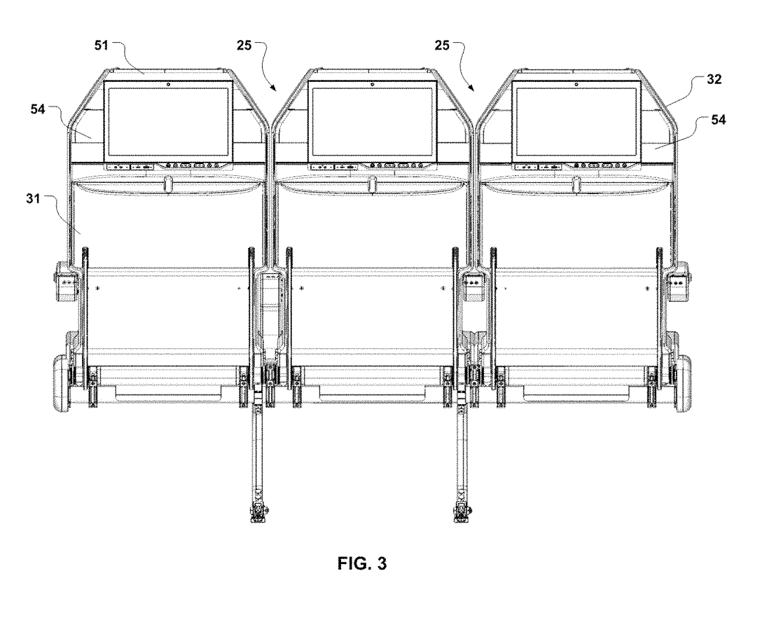

Other configurations of the upper body section are also possible. For example, the upper body section can have a continuous double tapering, with two tapered portions at different angles without a vertical portion. Another example is shown in FIG. 3 where a seat assembly 31 with a continuous single-level tapering 32 of the seatback is demonstrated. More generally, tapering of the seatback can be configured to provide an optimal gap 25, between a plurality of high seatbacks, that improves visibility, promotes a sense of spaciousness, prevents claustrophobia and satisfies safety requirements.

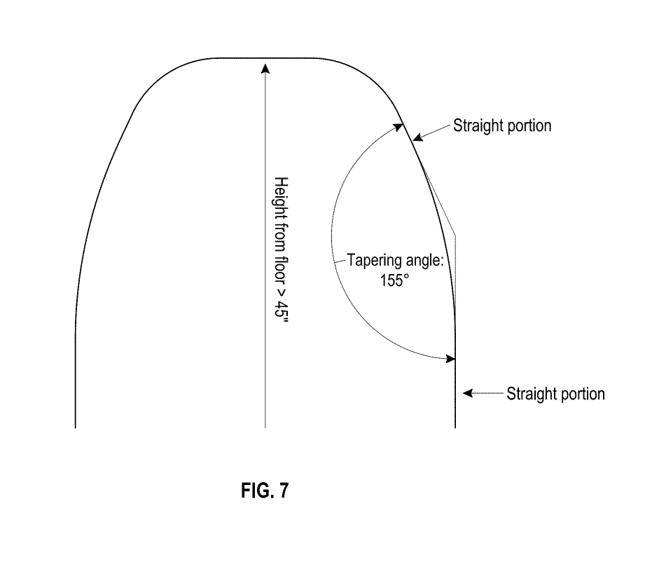

Another example configuration of the upper body section is depicted in FIG. 7. As shown, the seat can have a continuous single tapering, with a lower, vertical, straight portion gradually curving into an upper straight tapered portion. As shown, the seat can have some similar dimensions as the other seats discussed herein, such as having a height from the floor of at least 45 inches. The tapered portion can be at an angle of approximately 155 degrees, or otherwise can be between 120 and 160 degrees. The transition from the vertical portion to the tapered portion can be gradually curved (as shown in FIG. 7), or can be substantially discontinuous (such as that shown in FIG. 3). Further variations are also possible.

The various seats described herein can also provide adequate visibility to see a person behind the seat. For example, the seats can define a profile in the coronal plane such that a standing person having a height of 5 feet, standing behind the seat, can be seen by somebody in front of the seat. For example, a stewardess (or other person) in an airplane cabin can see the person behind a seat. The seat can define an area in the coronal plane through which the standing person behind the seat can be seen. More specifically, the seat can have a maximum horizontal width (for example, corresponding to the general torso of the seated person), and a top portion (which can be, for example, at least 45 inches above the ground). A vertical line tangent to the profile of the seat in the coronal plane at the maximum horizontal width, a horizontal line tangent to the top of the seat, and the profile of the seat itself can define an area on each side of the seat that can be substantially triangular (although the area may include more than three sides, or non-straight sides). The area on either side of the seat can be at least 20 square inches. Even further, the area can include at least 10 square inches below a height of 45 inches from the ground, ensuring sufficient area for viewing of people below that height.

When the seats are symmetric and arranged adjacent to each other, a comparable area defined by adjacent seats can form an area of at least 40 square inches, and this area can be sufficient to easily see a person behind the seat (as best shown in FIG. 2). In further embodiments, the seats can optionally be asymmetric, but still create a comparable area to that described herein.

Even further, distance between the seats at the maximum horizontal width can also increase the space for viewing of a person standing behind the seats. However, increasing this space can also reduce the amount of space on the seat to support the user. In some embodiments, this distance can be no more than 3 inches.

More generally, moving from a substantially rectangular seat shape, as used in many prior art seating systems in transportation settings (such as that shown in U.S. Patent Publication Nos. 2014/0300171 and 2013/0169009, both incorporated by reference in their entirety), to a tapered shape can allow for improved visibility without overly reducing comfort. For example, this can allow a taller and wider seat.

Configurations such as those described herein can be deployed in passenger seats for mass transportation vehicles such as, but not limited to, aircrafts, trains, and watercrafts in any number of seating configurations (e.g. single-seat, double-seat, triple-seat, quadruple-seat, etc.) or tapering configuration (e.g. continuous, non-continuous, single, double, etc.). The seat configurations depicted in the figures are not intended to restrict the application or scope of the application in any way.

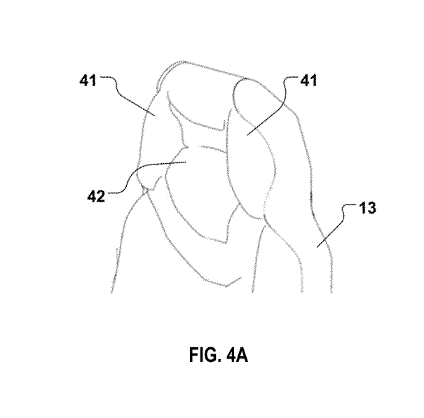

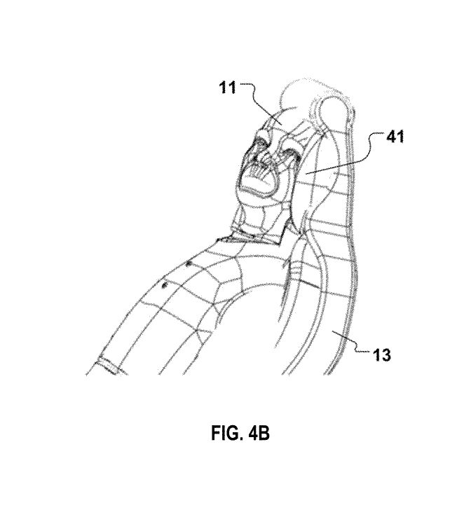

It is apparent from FIG. 1 that a seatback with an ergonomically fitting height 13 enables adequate head and neck support for an average passenger 11. FIGS. 4A and 4B illustrate perspective views of a fixed ergonomic headrest including side bolsters 41 and head/neck support pads 42 that can further improve the ergonomic fit of the seat. The head support pad (depressed) and neck support pad (protruded) 42 closely follow an anthropometrically correct body contour based on 3D scanning reconstruction of an average passenger. Soft wadding materials such as polyfill or fiberfill, and fast-recovery viscoelastic foam (especially for the protruded neck support) can be used in the support pads 42 to simulate a pillow-like consistency so that the passenger's head can sink in and not fall out of the seat during rest. Furthermore, the side bolsters 41 can optionally be in a fixed position, lacking any mechanically moving component that could break (such as U.S. Patent Publication No. 2004/0007910, which is incorporated by reference in its entirety). Such side bolsters 41 can be made of a foam laminate, based on polyurethane or otherwise, with a softer outer layer and a high-density core with or without a secondary structural reinforcement on the outermost faces. As depicted in FIG. 4B, the passenger may conveniently rest his head against the side bolsters 41 (adjacent the head and neck support pads 42) which restrain any sideways movement during rest. The headrest can also optionally include no moving parts, or otherwise be in a substantially fixed position.

A high seatback can further provide extra space on the rear side of the seat which may be used to integrate secondary components. FIGS. 5A and 5B are a rear view along with a perspective view of a high seatback assembly 13 showing an integrated storage compartment 51 and a display 53. The storage compartment can be further used as a literature pocket, for storing safety information card and other reading materials 52 such as, magazines, newspapers, etc. that can be accessible to a person seated behind the seat (such as in a row behind the seat). This compartment can optionally extend below and behind the designated area for the display 53, or can be limited so as not to extend beyond the designated area to conserve space.

In either case, the storage can be concealed by the display 53 in a normal configuration. The display can be an electronic display such as an LCD or other graphical interface. In some embodiments, the display 53 can be moved (fully removed, pivoted upward or in another direction, or otherwise moved) such as for cleaning and maintenance, as shown in the perspective view of FIG. 5B. Additionally, the display 53 can either be an as-provided display or the passenger's own device such as an electronic tablet that can be secured on a fixed or adjustable mounting platform via mechanical or magnetic attachment on the seat. The mounting features can allow a passenger to easily attach their own display devices to the seat. In FIG. 5A, a non-continuous double tapering as described above, with a primary tapering portion 22, followed by a straight and vertical portion 23 and a secondary tapering 24 is portrayed. Tapering configurations can be arranged in any number of fashions to leave sufficient clearance for display screens of various dimensions (here a 16:9 widescreen display is depicted) as well as service units 54, for example power outlet, USB port, audio jack, etc. As shown in FIG. 5A, the straight and vertical portion 23 can be positioned to accommodate the display 53, and also match the shoulders of a passenger (as shown best in FIG. 2). In some embodiments, the display can have a diagonal size of at least 9 inches. Similar displays can be similarly sized and positioned in other embodiments, such as embodiments with a single tapering portion. The display can be positioned on a rear side of the seat such that it can be at or above a bottom of the tapered portions on the sides of the seat. For example, the display can optionally be positioned entirely above the bottom of the tapered portions. In embodiments where the sides of the seat include a vertical portion above a tapered portion, the display can optionally be positioned between the vertical portions, and also be adjacent the vertical portions to span the entire horizontal space available.

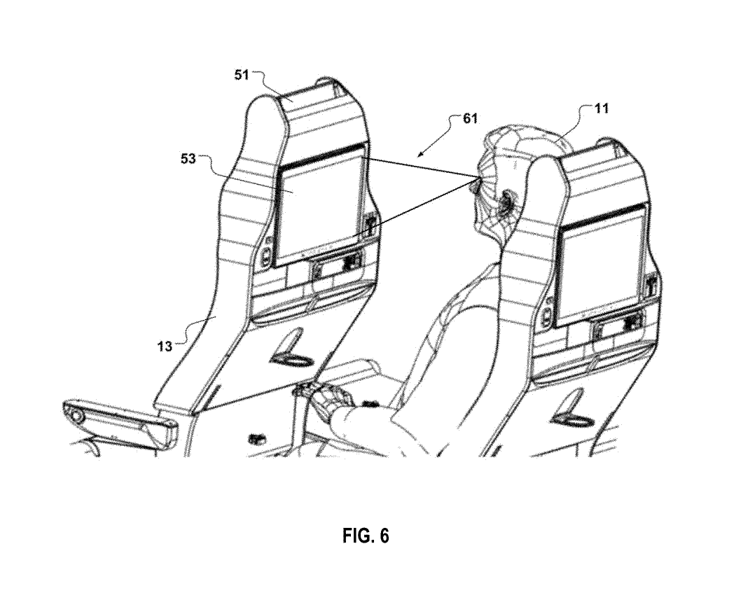

Furthermore, passengers using prior art seats often have to tilt their head slightly downward to maintain a direct line-of-sight with the display. This is due to the low height at which the display is placed (as readily observed in the side view presented in FIG. 1) and in an extended period of time this may lead to neck fatigue and shoulder ache. FIG. 6 is a perspective view of a seat assembly 13 exhibiting improved ergonomics of a passenger's line of sight 61 with a heightened display (for example, having a center point of the display at least 38 inches from the ground). The position of integrated storage compartment 51 with respect to an average passenger 11 is also shown in FIG. 6. It is evident that storing items in such a compartment does not take away from passenger's living space, whereas a traditional literature pocket protrudes outward and hence impacts legroom negatively.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof which include known equivalents and foreseeable equivalents at the time of filing this patent application.

What is claimed is:

1. A passenger seat assembly providing high visibility behind the seat while also having a high seatback, said seatback comprising:
a lower body section positioned to receive a lower body of a user in a seated position; and
an upper body section positioned to receive an upper body of a user in a seated position, the upper body section being operably connected to the lower body section and defining a profile in the coronal plane such that a standing-person having a height of 5 feet behind the seat assembly can be seen by somebody in front of the seat assembly in the context of an airplane cabin, the profile comprising a top at least 45 inches from the ground and two sides comprising tapered portions at an angle between 120 and 160 degrees; and
a display disposed on a rear side of the upper body section, at or above a bottom of the tapered portions, and having a diagonal size of at least 9 inches.

2. The passenger seat assembly of claim 1, wherein the upper body section comprises a headrest portion in a fixed position.

3. The passenger seat assembly of claim 2, wherein the headrest portion does not comprise any moving parts.

4. The passenger seat assembly of claim 2, wherein the headrest portion comprises a combination of soft wadding materials such as but not limited to polyfill or fiberfill, and/or fast-recovery viscoelastic foam to simulate a pillow-like consistency to help a passenger's head sink in and not fall out of the seat.

5. The passenger seat assembly of claim 4, wherein the headrest portion comprises side bolsters in a fixed position.

6. The passenger seat assembly of claim 5, wherein the side bolsters consist of a foam laminate with a softer outer layer and a high-density core.

7. The passenger seat assembly of claim 2, wherein the headrest portion comprises a neck support portion in form of a protruded padding of soft wadding materials such as but not limited to polyfill or fiberfill, and/or fast-recovery viscoelastic foam to adapt to body contours of passengers of different height.

8. The passenger seat assembly of claim 1, further comprising a storage compartment at the top portion, the storage compartment being accessible to a person seated behind the passenger seat assembly.

9. The passenger seat assembly of claim 1, further comprising a mounting portion configured to receive the display, the mounting portion further allowing the display to be removed and replaced by a passenger seated behind the seat assembly.

10. The passenger seat assembly of claim 1, wherein the profile comprises vertical portions along the sides, above the tapered portions.

11. The passenger seat assembly of claim 10, wherein the display is disposed between the vertical portions.

12. A passenger seat assembly providing high visibility behind the seat while also having a high seatback, said passenger seat assembly comprising:
a lower body section positioned to receive a lower body of a user in a seated position; and
an upper body section positioned to receive an upper body portion of a user in a seated position, the upper body section being operably connected to the lower body section and defining a profile in the coronal plane, the profile in the coronal plane comprising a top portion defining a highest point on the seatback and a maximum horizontal width, the maximum horizontal width occurring at an intermediate portion,
wherein a substantially triangular area in the coronal plane is defined on either side of the seat by a horizontal line tangent to the top portion, a vertical line tangent to the profile at the maximum horizontal width, and the profile, the substantially triangular area being at least 20 square inches.

13. The passenger seat assembly of claim 12, wherein the highest point of the seatback is at least 45 inches from the ground.

14. The passenger seat assembly of claim 12, wherein the upper body section comprises a headrest portion in a fixed position.

15. The passenger seat assembly of claim 12, further comprising a display disposed on a posterior side of the upper body section, the display providing a screen size of at least 9 inches.

16. The passenger seat assembly of claim 15, wherein the center point of display is at least 38 inches from the ground.

17. The passenger seat assembly of claim 12, further comprising a storage compartment at the top portion, the storage compartment being accessible to a person seated behind the passenger seat assembly.

18. The passenger seat assembly of claim 12, wherein the substantially triangular area on each side of the seat comprises an area of at least 10 square inches below 45 inches.

19. The passenger seat assembly of claim 12, wherein the profile tapers at an angle of between 120 degrees and 160 degrees from vertical.

20. The passenger seat assembly of claim 12, wherein, the lower body section and the upper body section are configured to rotate relative to each other.

21. A passenger seat system comprising at least two of the passenger seat assemblies of claim 12 arranged adjacent to each other.

22. The passenger seat system of claim 21, wherein the seats are no more than 3 inches apart at the maximum horizontal width.
